(19) United States
(12) Patent Application Publication
(10) Pub. No.: US 2007/0008388 A1
(43) Pub. Date: Jan. 11, 2007

(54) Liquid drop discharge head, liquid drop discharge device, and image forming device

(76) Inventors: Kiyoshi Yamaguchi, Kanagawa (JP); Takafumi Sasaki, Kanagawa (JP)

Correspondence Address: COOPER & DUNHAM, LLP, 1185 AVENUE OF THE AMERICAS, NEW YORK, NY, 10036, US

(21) Appl. No.: 10/555,041

(22) PCT Filed: Feb. 23, 2005
(86) PCT No.: PCT/JP05/03443

§ 371 Date: Oct. 27, 2005

(30) Foreign Application Priority Data
Mar. 2, 2004 (JP) 2004-057044

(51) Int. Cl. B41J 2/045

(52) U.S. Cl. 347/68

(57) ABSTRACT

A liquid drop discharge head includes a nozzle configured to discharge a liquid drop by using a piezoelectric element. Lead ingredients are not included in the piezoelectric element.

### TECHNICAL FIELD

The present invention relates to liquid drop discharge heads, liquid drop discharge devices, and image forming devices.

### BACKGROUND ART

An ink jet recording device having a liquid drop discharge device including a liquid drop discharge head is known as an image forming device such as a printer, facsimile, copier, and multifunction device of the printer, facsimile, and copier.

In the ink jet recording device, a liquid drop of a recording liquid is jetted from a recording head to a recorded medium such as a paper, an OHP (Overhead Projector) film, a recording medium or a recording paper, so that image forming such as recording, printing, or copying can be performed. It is possible to record a high precision image with high speed by the ink jet recording device on the recording medium. In addition, running cost is cheap and noise is small in the ink jet recording device. Furthermore, it is easy to record a color image by using a lot of kinds of colors, in the ink jet recording device.

As the inkjet head used for such an inkjet recording device, an inkjet head having a liquid room such as a pressing room, pressing liquid room, pressure room, a vibration room, and a piezoelectric element is known. The liquid room is connected to the nozzle for discharging the liquid drop. The vibration plate forms a part of a side surface of the liquid room. The piezoelectric element functions as an electrical-mechanical conversion element which deforms the vibration plate.

As disclosed in Japanese Patent Laid-Open Application Publications No. 2003-94652 and No. 2003-237065 and Japanese Patent No. 3178414, a PZT group formed by adding a small amount of an additive such as niobium oxide to a solid solution of lead zirconate (PbZrO₃) and lead titanate (PbTiO₃), is used as a piezoelectric material forming a piezoelectric element used for such an inkjet recording device. In addition, a solid solution generally called “ternary system” and formed by dissolving a lead group compound perovskite such as Pb(Mg_{1/3}Nb_{2/3})O₃ into the PZT is also used as the piezoelectric material forming the piezoelectric element used for such an inkjet recording device.

Since the Curie temperature of the PZT is high (360° C.), the PZT may not be influenced by heat in a head manufacturing process. In addition, since the sintering temperature of the PZT is relatively low (900 through 1200° C.), a low cost metal can be used for an internal layer electrode.

However, the above-discussed piezoelectric ceramic material includes lead oxide, which is not preferable for an ecological system, as approximately 70% of the whole weight. Therefore, in a case where the above-discussed piezoelectric ceramic material is thrown away, it is expected that a lead compound will be diffused into a natural environment due to acid precipitation and thereby a bad influence to a human body or the ecological system may be expected.

Furthermore, there is the following problem that is peculiar to the ink jet recording device using the piezoelectric element. That is, since the ink jet printer is cheaper than other image forming type printers, a large number of the ink jet printers are consumed for general individual users. In a case where the piezoelectric element including lead is used for such a cheap printer, a ratio of cost for collecting lead against benefit obtained by selling the printer is high. In addition, since the head part is mechanically positioned with an extremely high precision, the cost for dismantling of the printer is high. Because of this, a manufacturer's load for the collection of the lead is extremely high.

### DISCLOSURE OF THE INVENTION

Accordingly, it is a general object of the present invention to provide a novel and useful liquid drop discharge head, liquid drop discharge device, and image forming device.

Another and more specific object of the present invention is to provide a liquid drop discharge head which discharges a liquid drop by using a piezoelectric element not including lead ingredients so that the risk of environmental pollution and dismantling cost can be made low, a liquid drop discharge device having the liquid drop discharge head, and an image forming device.

The above object of the present invention is achieved by a liquid drop discharge head, including:

a nozzle configured to discharge a liquid drop by using a piezoelectric element;

wherein lead ingredients are not included in the piezoelectric element.

The above object of the present invention is also achieved by a liquid drop discharge device, including:

a liquid drop discharge head configured to discharge a liquid drop;

wherein the liquid drop discharge head includes a nozzle configured to discharge the liquid drop by using a piezoelectric element, and

lead ingredients are not included in the piezoelectric element.

The above object of the present invention is also achieved by an image forming device configured to form an image on a recording medium by discharging a liquid drop of recording liquid, including:

a liquid drop discharge head configured to discharge the liquid drop;

wherein the liquid drop discharge head includes a nozzle configured to discharge the liquid drop by using a piezoelectric element, and

lead ingredients are not included in the piezoelectric element.

Other objects, features, and advantages of the present invention will become more apparent from the following detailed description when read in conjunction with the accompanying drawings.

### BRIEF DESCRIPTION OF THE DRAWINGS

FIG. 1 is a perspective view of the exterior of a liquid drop discharge head of a first embodiment of the present invention;

FIG. 2 is an exploded perspective view of the liquid drop discharge head of the first embodiment of the present invention;

FIG. 3 is a cross-sectional view of the liquid drop discharge head of the first embodiment of the present invention;

FIG. 4 is a perspective view of a piezoelectric actuator of the liquid drop discharge head of the first embodiment of the present invention;

FIG. 5 is an enlarged perspective view of parts of the piezoelectric actuator shown in FIG. 4;

FIG. 6 is a structural view showing an example of a mechanism part of an image forming device including a liquid drop discharge device of the present invention; and

FIG. 7 is a plan view of parts of the image forming device of the present invention.

### BEST MODE FOR CARRYING OUT THE INVENTION

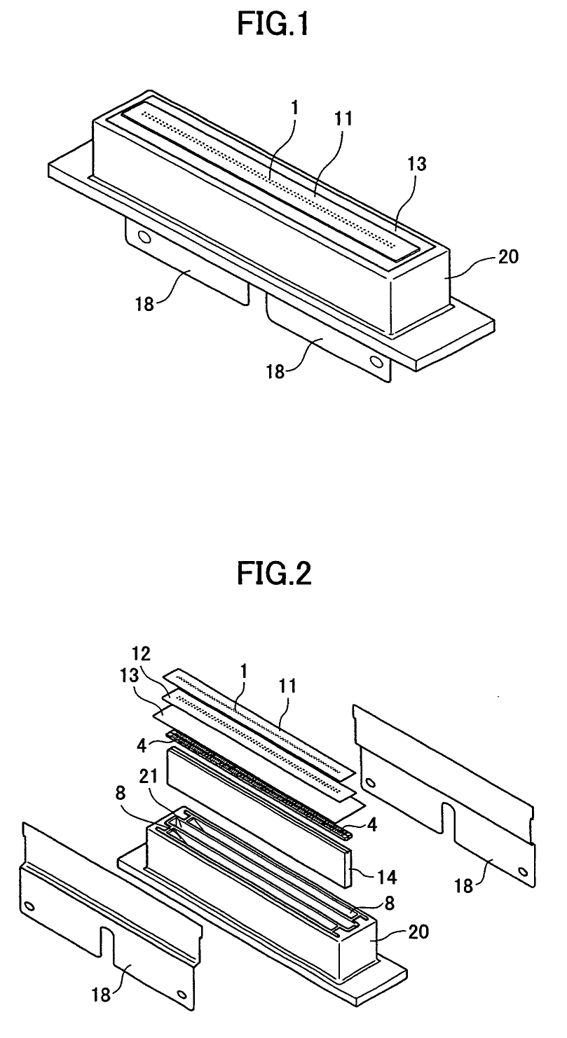

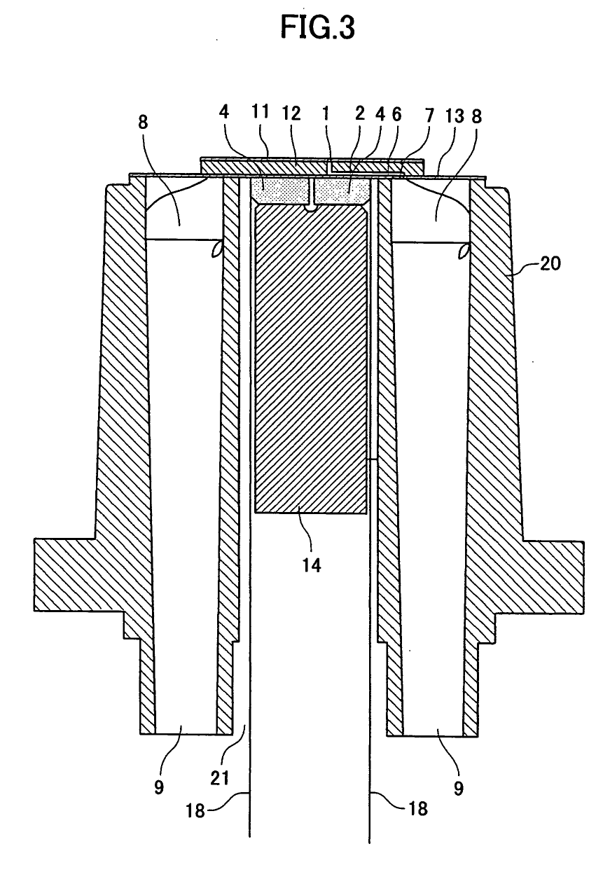

A description of the present invention and details of drawbacks of the related art are now given, with reference to FIG. 1 through FIG. 7, including embodiments of the present invention. First, the first embodiment of a liquid discharge head of the present invention is discussed with reference to FIG. 1 through FIG. 3. FIG. 1 is a perspective view of the exterior of the liquid drop discharge head. FIG. 2 is an exploded perspective view of the liquid drop discharge head. FIG. 3 is a cross-sectional view of the liquid drop discharge head.

The liquid drop discharge head has a nozzle 1 for discharging a liquid drop, a pressure room 2 connected to the nozzle 1, a vibration plate 3 (not shown) forming a part of a side surface of the pressure room 2, and a piezoelectric element 4 as actuator means such as pressure generation means or driving means for pressing the liquid in the pressure room 2 via the vibration plate 3. The liquid drop discharge head also has a common liquid room 8 and a supply opening part 9. The common liquid room 8 supplies ink as recording liquid to plural pressure rooms 2 via a liquid supply path 6 and a liquid supply opening 7. The supply opening part 9 supplies the ink from an outside to the common liquid room 8.

Two lines of the nozzles 1 are arranged in parallel lines on a nozzle plate 11. A plate formed by Ni electro-casting or the like is used for the nozzle plate 11, for example. However, other plate materials can be used as the nozzle plate 11. Each of the pressure rooms 2 is formed in a channel plate 12 made of a silicon substrate, for example. A vibration plate member 13 forming the vibration plate 3 is connected to a back surface side of the channel plate 12.

Under this structure, ink as recording liquid supplied from the outside to the common liquid room 8 is supplied to plural pressure rooms 2 via the liquid supply path 6 and the liquid supply opening 7. The inside of the pressure room 2 is pressed by deformation of the piezoelectric element 4 via the vibration plate 3 so that the liquid drop is discharged from the nozzle 1.

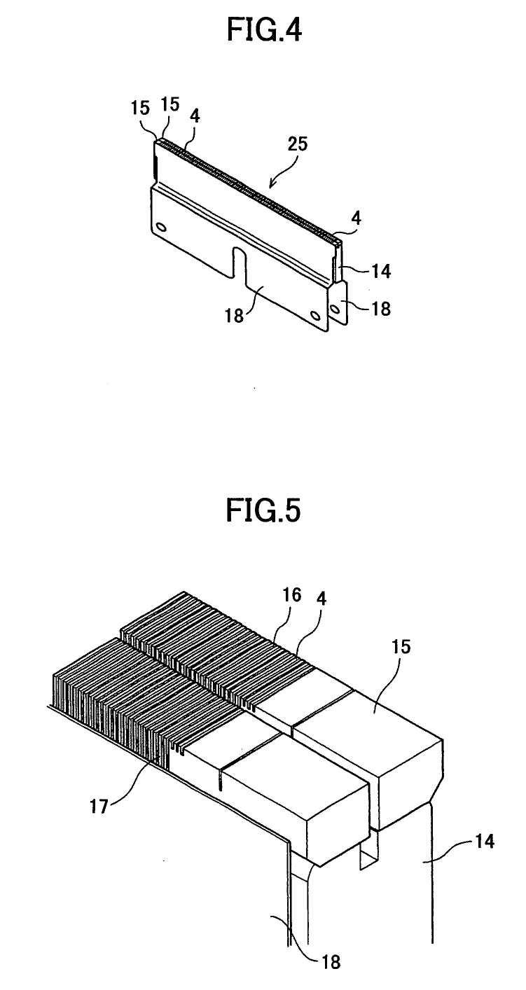

The piezoelectric element 4 is connected on a base 14 so as to correspond to the line of the nozzles 1. More specifically, as shown in FIG. 4 and FIG. 5, the piezoelectric element 4 is formed by making groves 16 on two piezoelectric members 15 connected on the base 14 in a comb tooth shape so that the grooves 16 correspond to the nozzles 1.

The piezoelectric element 4 is a stacked layer type piezoelectric element formed by reciprocally stacking a piezoelectric layer formed by a piezoelectric material (piezoelectric ceramic) not including lead and an inside electrode layer. The inside electrodes are reciprocally pulled out to an end surface so as to be connected to an end surface electrode (outside part electrode). An FPC 18 for supplying a driving signal is connected to an end surface electrode (outside part electrode) 17 functioning as an individual electrode and other end surface electrode functioning as a common electrode (not shown), via an anisotropic conductive film.

The common liquid room 8 is formed in a frame member 20. A supply opening part 9 is formed in the frame member 20 as outside liquid supply means so that the ink is supplied from the ink cartridge or the sub tank. In addition, an opening part 21 is formed in the frame member 20 so that a piezoelectric unit 25 (See FIG. 4) including the piezoelectric element 4, the base 14, and the FPC 18 is received in the opening part 21. Furthermore, a circumferential edge part of the vibration plate member 13 is connected to the frame member 20.

As a piezoelectric material of the piezoelectric element 4 at this head, a piezoelectric material not including a lead ingredient is used. More specifically, a material whose main ingredient is a material of a perovskite type crystal structure not including lead, such as barium titanate (BaTiO₃) where barium zirconate (BaZrO₃) is dissolved, is used as the piezoelectric material.

The barium titanate where barium zirconate is dissolved has an electrical-mechanical coupling coefficient of 0.5, similar with PZT's electrical-mechanical coupling coefficient. Furthermore, the barium titanate where barium zirconate is dissolved has the perovskite type crystal structure and therefore it is possible to obtain a good piezoelectric property such as small crystal anisotropy.

Since the Curie temperature of the barium titanate where barium zirconate is dissolved is low (approximately 130° C.), an electric connection is to be made by the anisotropic conductive film whereby the electric connection can be made at a lower temperature than soldering. The connection can be made by other methods such as wire bonding.

In this embodiment, the barium titanate where barium zirconate is dissolved is used. However, barium titanate where a slight amount of Fe or K is included may be used.

Thus, since lead is not included at all in the piezoelectric element as the actuator means in the liquid drop discharge head, it is possible to make the environmental pollution risk low and make the dismantling cost low.

Next, the second embodiment of the liquid drop discharge head of the present invention is discussed. Since the structure of the second embodiment is the same as the first embodiment, an explanation of the structure of the second embodiment is omitted.

In the second embodiment, a ceramic whose main ingredient is potassium niobate (KNbO₃) that is a material having a perovskite type crystal structure not including lead is used as a piezoelectric material (piezoelectric ceramic) of the piezoelectric element 4.

The ceramic whose main ingredient is potassium niobate has an electrical-mechanical coupling coefficient of 0.5, similar with PZT's electrical-mechanical coupling coefficient. Furthermore, the ceramic whose main ingredient is potassium niobate has the perovskite type crystal structure and therefore it is possible to obtain a good piezoelectric property such as small crystal anisotropy. Since the Curie temperature of the ceramic whose main ingredient is potassium niobate is high (approximately 435° C.), it is possible to mount the FPC by soldering as well as the PZT.

Thus, in the second embodiment as well as the first embodiment, since lead is not included at all in the piezoelectric element as the actuator means in the liquid drop discharge head, it is possible to make the environmental pollution risk low and make the dismantling cost low.

Next, the third embodiment of the liquid drop discharge head of the present invention is discussed. Since the structure of the third embodiment is the same as the first embodiment, an explanation of the structure of the third embodiment is omitted.

In the third embodiment, a ceramic whose main ingredient is bismuth sodium titanate ((Bi_{0.5}Na_{0.5})TiO₃) that is a material having a perovskite type crystal structure not including lead is used as a piezoelectric material (piezoelectric ceramic) of the piezoelectric element 4.

Since a sintering temperature of the ceramic whose main ingredient is bismuth sodium titanate is equal to or less than 1200° C., it is possible to reduce the amount of the palladium, an extremely expensive metal, in the internal layer electrode, so that it is possible to manufacture the piezoelectric element 4 at low cost.

Thus, in the third embodiment as well as the first and second embodiments, since lead is not included at all in the piezoelectric element as the actuator means in the liquid drop discharge head, it is possible to make the environmental pollution risk low and make the dismantling cost low.

Next, the fourth embodiment of the liquid drop discharge head of the present invention is discussed. Since the structure of the fourth embodiment is the same as the first embodiment, an explanation of the structure of the fourth embodiment is omitted.

In the fourth embodiment, a ceramic whose main ingredient is nickel sodium titanate (BBi(Ni_{0.5}Ti_{0.5})O₃) that is a material having a perovskite type crystal structure not including lead is used as a piezoelectric material (piezoelectric ceramic) of the piezoelectric element 4.

Since the Curie temperature of the ceramic whose main ingredient is nickel sodium titanate is relatively high (approximately 250° C.), it is possible to mount the FPC by soldering as well as the PZT.

Thus, in the fourth embodiment as well as the above-discussed embodiments, since lead is not included at all in the piezoelectric element as the actuator means in the liquid drop discharge head, it is possible to make the environmental pollution risk low and make the dismantling cost low.

Next, the fifth embodiment of the liquid drop discharge head of the present invention is discussed. Since the structure of the fifth embodiment is the same as the first embodiment, an explanation of the structure of the fifth embodiment is omitted.

In the fifth embodiment, a ceramic whose main ingredient is Ba₂NaNb₅O₁₅ that is a material having a tungsten bronze type crystal structure is used as a piezoelectric material (piezoelectric ceramic) of the piezoelectric element 4.

In a material group whose main ingredient is Ba₂NaNb₅O₁₅ that is the material having the tungsten bronze type crystal structure, a piezoelectric strain d33 coefficient is large (250 pC/N) and therefore it is possible to drive the material at a low voltage. Hence, it is possible to reduce the cost for a driving circuit and form an image forming device having high functions at a low cost.

Thus, in the fifth embodiment as well as the above-discussed embodiments, since lead is not included at all in the piezoelectric element as the actuator means in the liquid drop discharge head, it is possible to make the environmental pollution risk low and make the dismantling cost low.

Next, the sixth embodiment of the liquid drop discharge head of the present invention is discussed. Since the structure of the sixth embodiment is the same as the first embodiment, an explanation of the structure of the sixth embodiment is omitted.

In the sixth embodiment, a ceramic whose main ingredient is Bi₄Ti₃O₁₂, which is a material of a bismuth layered compound, is used as the piezoelectric material (piezoelectric ceramic) of the piezoelectric element 4.

In a material group whose main ingredient is Bi₄Ti₃O₁₂ that is a material having a bismuth layered compound, a piezoelectric strain d33 coefficient is relatively large and therefore it is possible to drive the material at a low voltage. Hence, it is possible to reduce the cost for a driving circuit and form an image forming device having high functions at a low cost. Since alkali metal is not used as a composition element, it is possible to obtain good composition controllability at the time of burning and therefore to obtain good mass production.

Thus, in the sixth embodiment as well as the above-discussed embodiments, since lead is not included at all in the piezoelectric element as the actuator means in the liquid drop discharge head, it is possible to make the environmental pollution risk low and make the dismantling cost low.

A material whose main ingredient has the perovskite type crystal structure not including lead is not limited to the above-discussed barium titanate, potassium niobate, bismuth sodium titanate, and nickel sodium titanate. Similarly, the material having the tungsten bronze type crystal structure is not limited to above-discussed Ba₂NaNb₅O₁₅. Similarly, the material having the bismuth layered compound type crystal structure is not limited to the above-discussed Bi₄Ti₃O₁₂.

In addition, the present invention can be applied to not only the above-discussed head using the stacked layer type piezoelectric element but also a head using a Bimorph type piezoelectric element. Furthermore the present invention can also be applied to a head using the stacked layer type piezoelectric element wherein a deformation in a d33 direction or d31 direction is used.

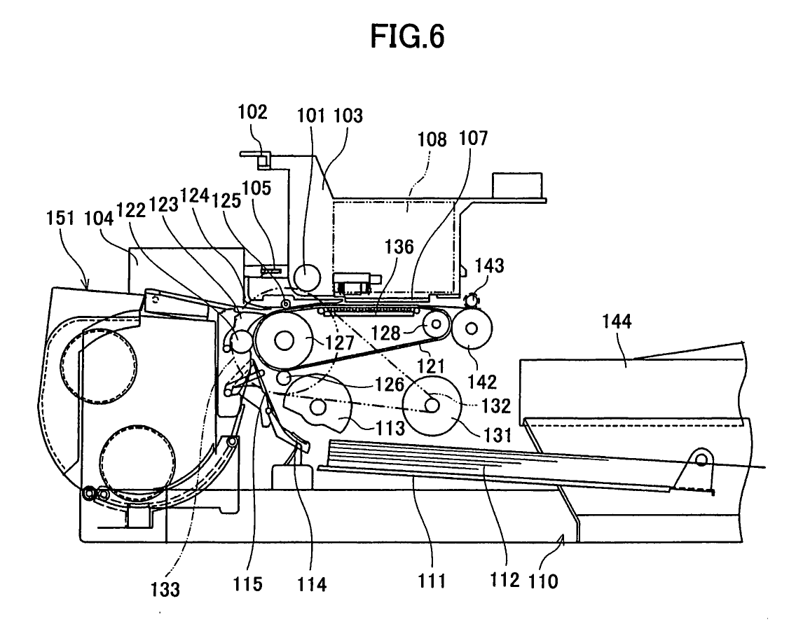

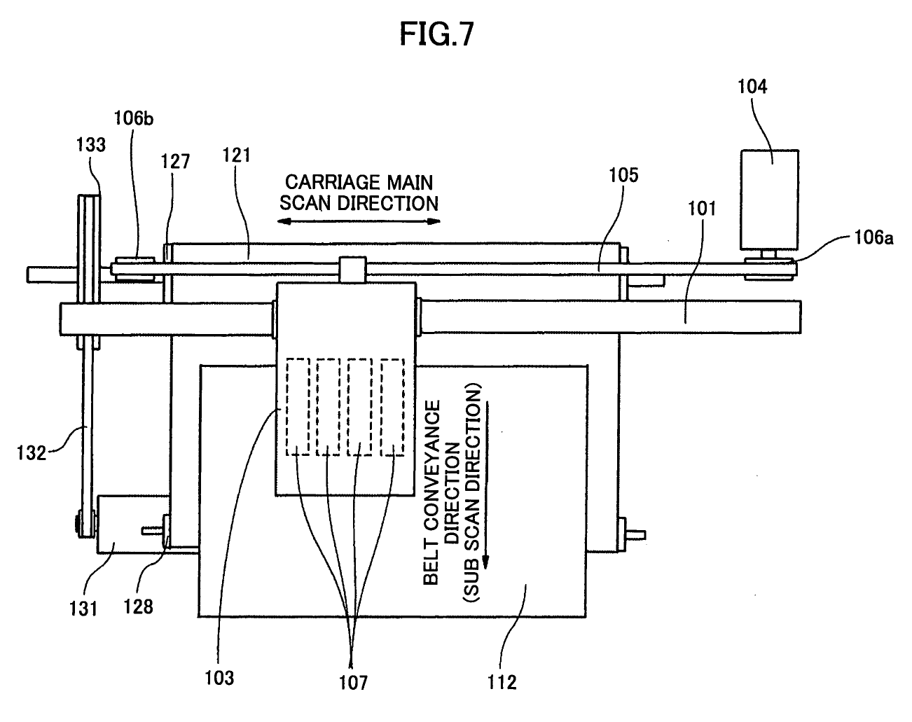

Next, an inkjet recording device as an image forming device of the present invention as a liquid discharge device having a liquid drop discharge head of the present invention is discussed with reference to FIG. 6 and FIG. 7. Here, FIG. 6 is a structural view showing an example of a mechanism part of the image forming device including the liquid drop discharge device of the present invention. FIG. 7 is a plan view of parts of the image forming device of the present invention.

In the image forming device, a carriage 103 is held by a guide rod 101 and a stay 102 which are guide members bridging between left and right side plates (not shown), so as to be capable of being slid in a main scan direction. A timing belt is provided at the carriage 103 and between a pulley 106a provided at a main scanning motor 104 and a pulley 106b provided at the other side. The carriage 103 is moved and caused to scan via the timing belt 105 by the main scanning motor 104 in the carriage main scan direction as shown in FIG. 7. In the carriage 103, an ink jet recording head 107 is provided in a direction in which plural ink jet opening parts are cross the main scanning direction. The recording head 107 is also provided so that the ink drop jet direction is downward. The four ink jet recording heads 107 respectively jet ink drops having colors of yellow(Y), cyan(C), magenta(M), and black(Bk).

Furthermore, sub tanks 108 for colors are provided at the carriage 103 so that corresponding ink colors are provided to the recording heads 107. Supplemental ink is supplied from a main tank, namely an ink cartridge, to the sub tank 108 via the ink supply tube (not shown).

Furthermore, as a paper feeding part for feeding paper 112 (including not only paper per se but also OHP (Overhead Projector) film, and means a material where an image is formed) stacked on a paper stacking part (pressure plate) 111 of the paper feeding tray 110, a half circle roller (paper feeding roller) 113 and a separation pad 114 are provided. One sheet of the paper 112 is separately fed from the paper stacking part 111 by the half circle roller 113. The separation pad 114 made of material having a large coefficient of friction faces the half circle roller (paper feeding roller) 113 and is energized to a side of the half circle roller 113.

As a conveyance part for conveying the paper 112 fed from the paper feeding part at a lower side of the recoding heads 107, a conveyance belt 121, a counter roller 122, a conveyance guide 123, and a head end pressuring roller 125 are provided. The conveyance belt 121 electrostatically attaches and conveys the paper 112. The paper 112 sent from the paper feeding part via the guide 115 is put between the conveyance belt 121 and the counter roller 122 so as to be conveyed. By the conveyance guide 123, the paper 112 is sent in the upward direction, is then turned substantially 90 degrees, and then the paper 112 is conveyed on the conveyance belt 121. The head end pressuring roller 125 is pushed to a side of the conveyance belt 121 by a pressing member 124. In addition, a charging roller 126 is provided as charging means for charging a surface of the conveyance belt 121. The conveyance belt 121 is an endless belt. The conveyance belt 121 is hung between the conveyance roller 127 and a tension roller 128. The conveyance belt 121 revolves in a belt conveyance direction, namely a sub scanning direction, by rotating the conveyance roller 127 via the timing belt 132 and the timing roller 133 by the sub scanning motor 131.

The conveyance belt 121 has a surface layer and a back surface layer. The surface layer 121a (not shown) functions as a paper attraction surface formed by, for example, a pure resin material which has a thickness of approximately 40 μm and whose resistance is not controlled, such as ETFE (Ethylene Tetrafluoroethylene) pure material. The back surface, such as a middle resistance layer or an earth layer, is made of the same material as the surface layer. The resistance of the back surface layer is controlled by carbon content.

The charging roller 126 comes in contact with the surface layer of the conveyance belt 121 and rotates as following the rotation of the conveyance belt 121. The charging roller 126 gives 2.5 N to both ends of the shaft as pressurizing forces. The conveyance roller 127 works as a ground roller so as to contact a middle resistance layer (back layer) of the conveyance belt 121 for grounding.

A guide member 136 is arranged at a back side of the conveyance belt 121 as corresponding to a printing area by the recording heads 107. An upper surface of the guide member 136 projects to a side of the recording heads 107 more than a tangent of two rollers (the conveyance roller 127 and the tension roller 128) supporting the conveyance belt 121. Under this structure, in the printing area, the conveyance belt 121 is pushed by the upper surface of the guide member 136 so as to be guided.

Furthermore, as a paper discharging part for discharging the paper 112 recorded on by the recording heads 107, a separation claw for separating the paper 112 from the conveyance belt 121, a discharging roller 142, and a discharging roller 143 are provided. The paper discharging tray 144 is provided for holding the discharged papers 112. A both-surfaces paper feeding unit 151 is detachably arranged at a back surface part of the device main part. The both-surfaces paper feeding unit 151 takes in the paper 112 returned by reverse direction revolution of the conveyance belt 121 and turns the paper 112 over so as to feed the paper 112 again between the counter roller 122 and the conveyance belt 121.

In the ink jet recording device having the above-discussed structure, one sheet of the paper 112 is separately fed from the feeding part. The paper 112 fed upward in a substantially vertical direction is guided by the guide 115. The paper 112 is put between the conveyance belt 121 and the counter roller 122 so as to be conveyed. Furthermore, a head end part of the paper 112 is guided by the conveyance guide 123 and pushed to the conveyance belt 121 by the head end pressure roller 125 so that the direction of the paper 112 is changed substantially 90 degrees.

At this time, by a control circuit (not shown in the drawings), a voltage is applied from a high voltage electric power supply to the charging roller 126 so that a positive output and a negative output repeat by turns. As a result of this, a charging voltage pattern is formed on the conveyance belt 121. That is, positive and negative charging is performed in a belt shape with a designated width in the sub scanning direction that is a revolution direction. The paper 112 is fed on the conveyance belt 121 positively and negatively charged by turns so that the paper 112 is adhered by the conveyance belt 121 electrostatically and the paper 112 is conveyed in the sub scanning direction by the revolving movement of the conveyance belt 121.

While the carriage 103 is moved, the recording heads 107 are driven corresponding to an image signal so that ink drops are jetted onto the paper 112 which is stopped and one line is recorded. After the paper 112 is conveyed with a designated distance, the next line is recorded. The recording process is terminated based on receipt of a recording finishing signal or a signal indicated the rear end of the paper 112 has arrived at the recording area, so that the paper 112 is discharged to the paper discharging tray 144.

Thus, since the image forming device has the liquid drop discharge head of the present invention, lead ingredients are not included in the head. Hence, even if the image forming device is thrown away, it is possible to prevent the lead ingredients from diffusing, furthermore costs for collecting and dismantling the image forming device can be low, and the image forming device can be reused easily.

The present invention is not limited to the above-discussed embodiments, but variations and modifications may be made without departing from the scope of the present invention.

For example, the inkjet recording device, one of examples of the image forming devices, is discussed as a liquid drop discharge device. However, the present invention is not limited to this. Various kinds of sheets, the OHP sheet, a plastic material such as a compact disk or a plastic material used for a decoration plate, a fabric, a metal material such as aluminum or copper, a leather material such as a cattle skin, a pig skin, or artificial leather, wood material such as a wood or wood plate, a bamboo material, a ceramic material such as a tile, a three dimensional structural body such as a sponge, or the like can be used as a recording medium where the liquid is such as the ink.

Furthermore, a printer device for recording on the various kinds of sheets or the OHP sheet, a recording device for recording on the plastic material such as the compact disk, a recording device for recording on the metal plate, a recording device for recording on the leather material, a recording device for recording on the wood, a recording device for recording on the ceramic material, a recording device for recording on the three dimensional structural body such as a sponge, a printing device for recording on the fabric, or the like, can be used as the liquid drop discharge device.

1. A liquid drop discharge head, comprising:
a nozzle configured to discharge a liquid drop by using a piezoelectric element;
wherein lead ingredients are not included in the piezoelectric element.

2. The liquid drop discharge head as claimed in claim 1,
wherein main ingredients of the piezoelectric element are materials having a perovskite type crystal structure not including lead.

3. The liquid drop discharge head as claimed in claim 2,
wherein main ingredients of the piezoelectric element are barium titanate.

4. The liquid drop discharge head as claimed in claim 2,
wherein main ingredients of the piezoelectric element are potassium niobate.

5. The liquid drop discharge head as claimed in claim 2,
wherein main ingredients of the piezoelectric element are bismuth sodium titanate.

6. The liquid drop discharge head as claimed in claim 2,
wherein main ingredients of the piezoelectric element are nickel sodium titanate.

7. The liquid drop discharge head as claimed in claim 1,
wherein main ingredients of the piezoelectric element are materials having a tungsten bronze type crystal structure.

8. The liquid drop discharge head as claimed in claim 7,
wherein main ingredients of the piezoelectric element are Ba₂NaNb₅O₁₅.

9. The liquid drop discharge head as claimed in claim 1,
wherein main ingredients of the piezoelectric element are materials having a bismuth layered compound.

10. The liquid drop discharge head as claimed in claim 9,
wherein main ingredients of the piezoelectric element are Bi₄Ti₃O₁₂.

11. A liquid drop discharge device, comprising:
a liquid drop discharge head configured to discharge a liquid drop;
wherein the liquid drop discharge head includes a nozzle configured to discharge the liquid drop by using a piezoelectric element, and
lead ingredients are not included in the piezoelectric element.

12. An image forming device configured to form an image on a recording medium by discharging a liquid drop of recording liquid, comprising:
a liquid drop discharge head configured to discharge the liquid drop;
wherein the liquid drop discharge head includes a nozzle configured to discharge the liquid drop by using a piezoelectric element, and
lead ingredients are not included in the piezoelectric element.
